(19) United States
(12) Patent Application Publication
(10) Pub. No.: US 2026/0329613 A1
(43) Pub. Date: Oct. 22, 2026

(54) REMOTE PROCEDURE CALL VIRTUALIZATION

(71) Applicant: QUALCOMM Incorporated, San Diego, CA (US)

(72) Inventors: Lanxing JIANG, Shanghai (CN); Jingfei LI, Shanghai (CN); Hao LIU, Shanghai (CN); Ping JIANG, Shanghai (CN); Hua ZHANG, Shanghai (CN)

(21) Appl. No.: 19/103,472

(22) PCT Filed: Aug. 16, 2022
(86) PCT No.: PCT/CN2022/112662

§ 371 Date: Feb. 12, 2025

(51) Int. Cl. G06F 9/455

(52) U.S. Cl. CPC G06F 9/45558; G06F 2009/45579; G06F 2009/45583

(57) ABSTRACT

Various embodiments include methods for implementing, in a processor of a computing device, remote procedure calls (RPCs). Embodiments may include the first processor configured to execute a plurality of guest virtual machines (GVMs) in parallel. Embodiments may include receiving a first plurality of RPC requests, by a first virtual RPC module that is executed by a GVM of the plurality of GVMs, from a plurality of RPC sources that are executed concurrently by the GVM, generating, by the first virtual RPC module, a plurality of RPC request messages from the first plurality of RPC requests, sending the plurality of RPC request messages from the first virtual RPC module to a memory of the computing device, retrieving the plurality of RPC request messages from the memory by a second virtual RPC module that is executed by the processor, and generating, by the second virtual RPC module, a second plurality of RPC requests for the plurality of RPC request messages.

### BACKGROUND

An increasing number of functions are being integrated into single controllers. Different functions may affect each other and require different real time ability, safety levels, and other parameters. In a single operating system (OS) architecture, the applications that implement complicated algorithms can invoke a remote procedure call (RPC) to offload computing tasks from a central processing unit (CPU) to a digital signal processor (DSP). In a multi-OS architecture, including a host OS and multiple guest OS such as in automotive systems, different types of applications run on different OSes. In multi-OS architecture systems, applications that execute complicated algorithms cannot directly invoke a RPC to a DSP.

### SUMMARY

Various aspects of this disclosure provide methods and computing devices implementing such methods in a first processor of a computing device of implementing remote procedure calls (RPCs), in which the first processor is configured to execute a plurality of guest virtual machines (GVMs) in parallel. Various aspects may include receiving a first plurality of RPC requests, by at least one first virtual RPC module that is executed by at least one GVM of the plurality of GVMs, from a plurality of RPC sources that are executed concurrently by the at least one GVM, generating, by the at least one first virtual RPC module, a plurality of RPC request messages from the first plurality of RPC requests, sending the plurality of RPC request messages from the at least one first virtual RPC module to a memory of the computing device, retrieving the plurality of RPC request messages from the memory by a second virtual RPC module that is executed by the first processor, and generating, by the second virtual RPC module, a second plurality of RPC requests for the plurality of RPC request messages.

In some aspects, receiving the first plurality of RPC requests may include receiving the first plurality of RPC requests concurrently.

In some aspects, the first plurality of RPC requests includes a first RPC request and a second RPC request from a first RPC source of the plurality of RPC sources, the first RPC request is directed to a second processor of the computing device and the second RPC request is directed to a third processor of the computing device, and generating the second plurality of RPC requests for the plurality of RPC request messages may include generating a third RPC request directed to the second processor and a fourth RPC request directed to the third processor.

In some aspects, the first plurality of RPC requests includes a first RPC request from a first RPC source of the plurality of RPC sources and a second RPC request from a second RPC source of the plurality of RPC sources, the first RPC request and the second RPC request are directed to a second processor of the computing device, and generating the second plurality of RPC requests for the plurality of RPC request messages may include generating a third RPC request directed to the second processor and a fourth RPC request directed to the second processor.

In some aspects, the at least one GVM includes a first GVM and a second GVM, the plurality of RPC sources includes the first GVM and the second GVM and the first plurality of RPC requests includes a first RPC request from the first GVM and a second RPC request from the second GVM, generating the plurality of RPC request messages from the first plurality of RPC requests may include generating a first RPC request message from the first RPC request and a second RPC request message from the second RPC request, sending the plurality of RPC request messages from the at least one first virtual RPC module to the memory may include pushing the first RPC request message to a first queue for the first GVM and pushing the second RPC request message to a second queue for the second GVM, and retrieving the plurality of RPC request messages from the memory by the second virtual RPC module may include retrieving the first RPC request message from the first queue for the first GVM and retrieving the second RPC request message from the second queue for the second GVM.

In some aspects, the at least one GVM includes a first GVM and a second GVM, the plurality of RPC sources includes the first GVM and the second GVM, the first plurality of RPC requests includes a first RPC request from the first GVM and a second RPC request from the second GVM, and the at least one first virtual RPC module includes a first virtual RPC module executed by the first GVM and a first virtual RPC module executed by the second GVM, generating the plurality of RPC request messages from the first plurality of RPC requests may include generating a first RPC request message from the first RPC request by the first virtual RPC module executed by the first GVM, and generating a second RPC request message from the second RPC request by the first virtual RPC module executed by the second GVM, and sending the plurality of RPC request messages from the at least one first virtual RPC module to the memory may include sending the first RPC request message by the first virtual RPC module executed by the first GVM to the memory, and sending the second RPC request message by the first virtual RPC module executed by the second GVM to the memory, and the aspects may further include sending a first RPC request notification for the first GVM from the first virtual RPC module executed by the first GVM to the second virtual RPC module, and sending a second RPC request notification for the second GVM from the first virtual RPC module executed by the second GVM to the second virtual RPC module, in which retrieving the plurality of RPC request messages from the memory by the second virtual RPC module may include retrieving the first RPC request message from the memory in response to receiving the first RPC request notification, and retrieving the second RPC request message from the memory in response to receiving the second RPC request notification.

In some aspects, the plurality of RPC sources includes a first application and a second application and the first plurality of RPC requests includes a first RPC request from the first application and a second RPC request from the second application, and generating the second plurality of RPC requests for the plurality of RPC request messages may include generating a third RPC request from the first application and a fourth RPC request from the second application, the aspects may further include pushing the third RPC request to a first thread pool for the first application, and pushing the fourth RPC request to a second thread pool for the second application.

In some aspects, generating the plurality of RPC request messages from the first plurality of RPC requests may include generating the plurality of RPC request messages with data of the plurality of RPC request messages from a first buffer and a buffer attribute of the first buffer, and generating the second plurality of RPC requests from the plurality of RPC request messages may include mapping a second buffer using the buffer attribute, storing the data of the plurality of RPC request messages to the second buffer, and generating the second plurality of RPC requests using the data of the plurality of RPC request messages from the second buffer.

In some aspects, the first plurality of RPC requests includes at least one RPC request from a first RPC source of the plurality of RPC sources, generating the plurality of RPC request messages from the first plurality of RPC requests may include generating at least one RPC request message using at least one file descriptor from a first persistent buffer for the data of the at least one RPC request message. Such aspects may include mapping a second persistent buffer for use by the first RPC source, retrieving the data of the at least one RPC request message using the at least one file descriptor from the at least one RPC request message, storing the data of the least one RPC request message to the second persistent buffer, in which generating the second plurality of RPC requests from the plurality of RPC request messages may include generating at least one RPC request of the second plurality of RPC requests using the data of the at least one RPC request message from the second persistent buffer.

Some aspects may further include setting a process attribute of the plurality of RPC sources, in which generating the plurality of RPC request messages from the first plurality of RPC requests may include generating the plurality of RPC request messages from the first plurality of RPC requests based on the process attribute, and setting the process attribute using the process attribute from the plurality of RPC request messages for implementing the second plurality of RPC requests.

Some aspects may further include receiving a first plurality of RPC results for the second plurality of RPC requests, generating a plurality of RPC result messages from the first plurality of RPC results, sending the plurality of RPC result messages from the second virtual RPC module to the memory, retrieving the plurality of RPC result messages from the memory by the at least one first virtual RPC module, and sending the plurality of RPC result messages from the at least one first virtual RPC module to the plurality of RPC sources.

In some aspects, the at least one GVM includes a first GVM and a second GVM, the plurality of RPC sources includes the first GVM and the second GVM, the first plurality of RPC results includes a first RPC result for the first GVM and a second RPC result for the second GVM, and the at least one first virtual RPC module includes a first virtual RPC module executed by the first GVM and a first virtual RPC module executed by the second GVM, generating the plurality of RPC result messages from the first plurality of RPC results may include generating a first RPC result message from the first RPC result and a second RPC result message from the second RPC result, sending the plurality of RPC result messages from the second virtual RPC module to the memory may include pushing the first RPC result message to a first queue of the first GVM and pushing the second RPC result message to a second queue of the second GVM, and retrieving the plurality of RPC result messages from the memory by the at least one first virtual RPC module may include retrieving the first RPC result message from the first queue of the first GVM by the first virtual RPC module executed by the first GVM, and retrieving the second RPC result message from the second queue of the second GVM by the first virtual RPC module executed by the second GVM.

In some aspects, the at least one GVM includes a first GVM and a second GVM, and the plurality of RPC sources includes the first GVM and the second GVM, and the at least one first virtual RPC module includes a first virtual RPC module executed by the first GVM and a first virtual RPC module executed by the second GVM, the first plurality of RPC results includes a first RPC result for the first GVM and a second RPC result for the second GVM, generating the plurality of RPC result messages from the first plurality of RPC results may include generating a first RPC result message from the first RPC result and a second RPC result message from the second RPC result, and sending the plurality of RPC result messages from the second virtual RPC module to the memory may include sending the first RPC result message and the second RPC result message to the memory, the aspects may further include sending a first RPC result notification for the first GVM from the second virtual RPC module to the first virtual RPC module executed by the first GVM and a second RPC result notification for the second GVM from the second virtual RPC module to the first virtual RPC module executed by the second GVM, in which retrieving the plurality of RPC result messages from the memory by the at least one first virtual RPC module may include retrieving, by the first virtual RPC module executed by the first GVM, the first RPC result message from the memory in response to receiving the first RPC result notification, and retrieving, the first virtual RPC module executed by the second GVM, the second RPC result message from the memory in response to receiving the second RPC result notification.

In some aspects, the first plurality of RPC requests includes a first RPC request from a first RPC source of the plurality of RPC sources, the second plurality of RPC requests includes a second RPC request derived from the first RPC request, the first plurality of RPC results for the second plurality of RPC requests includes a first RPC result for the second RPC request, generating the plurality of RPC result messages from the first plurality of RPC results may include generating a first RPC result message using at least one file descriptor for the first RPC result from a first persistent buffer, and retrieving the plurality of RPC result messages from the memory by the at least one first virtual RPC module may include retrieving the at least one file descriptor for the first RPC result from a second persistent buffer, the aspects may further include freeing the first persistent buffer storing the at least one file descriptor for the first RPC result, and freeing the second persistent buffer storing the at least one file descriptor for the first RPC result.

In some aspects, the plurality of RPC sources includes one or more of a plurality of guest virtual machines, a plurality of applications running on a guest virtual machine, or at least one application running on each of a plurality of guest virtual machines.

Further aspects include a computing device including a processor configured to perform operations of any of the methods summarized above. Further aspects include a non-transitory processor-readable storage medium having stored thereon processor-executable software instructions configured to cause a processor to perform operations of any of the methods summarized above. Further aspects include a computing device having means for accomplishing functions of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example computing device suitable for implementing various embodiments.

FIG. 2 is a perspective diagram illustrating an example multi-operating system (OS) architecture in a vehicle context suitable for implementing various embodiments.

FIG. 3 is a component block diagram illustrating an example remote procedure call (RPC) virtualization system for a multi-OS architecture suitable for implementing various embodiments.

FIG. 4A is a component block diagram illustrating an RPC virtualization system suitable for implementing various embodiments.

FIG. 4B is a process flow diagram illustrating a method for RPC virtualization according to various embodiments.

FIG. 5 is a component block and signaling diagram illustrating a RPC virtualization system suitable for implementing various embodiments.

FIG. 6 is a component block diagram illustrating an example mobile computing device suitable for implementing various embodiments.

FIG. 7 is a component block diagram illustrating an example mobile computing device suitable for implementing various embodiments.

FIG. 8 is a component block diagram illustrating an example server suitable for implementing various embodiments.

FIGS. 9A-9C are component block diagrams illustrating an example embedded vehicle computing system suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods and computing devices implementing such methods of implementing remote procedure call (RPC) virtualization. Various embodiments may include converting RPC requests originating from applications on guest virtual machines (GVM) to virtual RPC request messages by a front-end RPC module and sending the virtual RPC request messages to a back-end RPC module implemented on a host operating system. Some embodiments may include converting RPC results by the back-end RPC module to virtual RPC result messages and sending the virtual RPC result messages to the front-end RPC module. Some embodiments may include enabling multiple RPC requests originating from multiple applications and/or GVMs to be implemented on one or more processors, such as digital signal processors (DSPs).

The term “computing device” is used herein to refer to stationary computing devices including personal computers, desktop computers, all-in-one computers, workstations, super computers, mainframe computers, embedded computers (such as in vehicles and other larger systems), computerized vehicles (e.g., partially or fully autonomous terrestrial, aerial, and/or aquatic vehicles, such as passenger vehicles, commercial vehicles, recreational vehicles, military vehicles, drones, etc.), servers, multimedia computers, and game consoles. The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor.

Various embodiments are described in terms of code, e.g., processor-executable instructions, for ease and clarity of explanation, but may be similarly applicable to any data, e.g., code, program data, or other information stored in memory. The terms “code”, “data”, and “information” are used interchangeably herein and are not intended to limit the scope of the claims and descriptions to the types of code, data, or information used as examples in describing various embodiments.

The terms “guest operating system,” “guest OS,” “guest virtual machine,” and “GVM” are used interchangeably herein to refer to a virtual instance of an operating system implemented on a processing device.

The automotive electronic and electrical architecture (EEA) is increasingly centralized. Currently a domain controller integrates all functions of the domain into one controller. In the future, all functions may be controlled by one centralized vehicle computer. However, various functions may affect other different functions and require different real time abilities, safety levels, and others parameters.

Implementing a guest virtual machine (GVM) in the EEA may be used to isolate different functions in one system on chip (SoC). As such, implementation of a GVM is increasingly popular in automotive controllers.

However, the computational requirements for functions, such as for artificial intelligence (AI) modules, are increasing and providing sufficient performance of complicated algorithms running on GVMs is increasingly important to the goal of maintaining overall functional performance. Co-processing, such as offloading work to a digital signal processor (DSP), can help with complex computation performance. Remote procedure calls (RPC) can be used to send tasks to a DSP for execution and return the results to an application.

In a single operating system (OS) system, an application can invoke RPC to offload computing tasks from a processor, such as a central processing unit (CPU) to a DSP. However, in a multi-OS architecture multiple guest OSes may be implemented in a manner that is isolated from a host OS by a hypervisor. For example, a guest OS may be a GVM; however, applications executing on the GVM cannot directly invoke RPC to a DSP.

Various embodiments address and solve the foregoing problem by RPC virtualization. In various embodiments, RPC virtualization may transmit an RPC request from a guest OS to a host OS, and the host OS may invoke RPC to a DSP. RPC virtualization transfers RPC messages between the guest OS and the host OS via a shared memory and interrupts managed by a hypervisor. A guest RPC modules and a host RPC module may be implemented to enable the communication of RPC messages between the guest OS and the host OS. The guest RPC module and the host RPC module may implement virtual queues for the messages and enable multiple RPC requests from any number and combination of applications executing on any number and combination of guest OSes to be implemented on any number and combination of DSPs. For example, a single application may issue multiple RPC requests that may be implemented by one or more DSPs. As another example, multiple applications executing on one or more guest OSes may issue multiple RPC requests that may be implemented by one or more DSPs.

RPC virtualization may offload tasks of applications on GVMs to DSPs, reducing the workloads of the GVMs, which makes increase efficiency of use of computing resources. As a result increasingly complicated algorithms may be executed on an SoC.

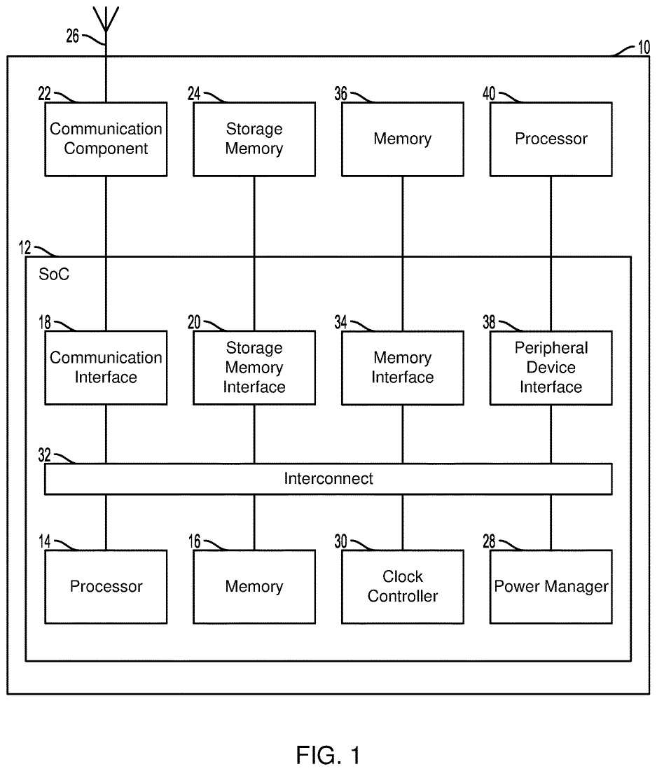

FIG. 1 illustrates a system including a computing device 10 suitable for use with various embodiments. With reference to FIG. 1, the computing device 10 may include a system-on-chip (SoC) 12 with a processor 14, a memory 16, a communication interface 18, a storage memory interface 20, a memory interface 34, a power manager 28, a clock controller 30, a processor interface 38, and an interconnect 32. The computing device 10 may further include a communication component 22, such as a wired or wireless modem, a storage memory 24, an antenna 26 for establishing a wireless communication link, a memory 36, and a processor 40. The processors 14, 40 may include any of a variety of processing devices, for example a number of processor cores.

The term “system-on-chip” (SoC) is used herein to refer to a set of interconnected electronic circuits typically, but not exclusively, including a processing device, a memory, and a communication interface. A processing device may include a variety of different types of processors 14, 40 and processor cores, such as a general purpose processor, a central processing unit (CPU), a digital signal processor (DSP), a graphics processing unit (GPU), an accelerated processing unit (APU), a secure processing unit (SPU), a subsystem processor of specific components of the computing device, such as an image processor for a camera subsystem or a display processor for a display, an auxiliary processor, a single-core processor, a multicore processor, a controller, and a microcontroller. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

An SoC 12 may include one or more processors 14. The computing device 10 may include more than one SoC 12, thereby increasing the number of processors 14 and processor cores. The computing device 10 may also include processors 40 that are not integrated with an SoC 12. The processors 14, 40 may each be configured for specific purposes that may be the same as or different from other processors 14, 40 of the computing device 10. One or more of the processors 14, 40 and processor cores of the same or different configurations may be grouped together. A group of processors 14, 40 or processor cores may be referred to as a multi-processor cluster.

The memory 16, 36 of the SoC 12 may be a volatile or non-volatile memory configured for storing data and processor-executable code for access by the processors 14, 40. The computing device 10 and/or SoC 12 may include one or more memories 16, 36 configured for various purposes. One or more memories 16, 36 may include volatile memories such as random access memory (RAM) or main memory, including static RAM (SRAM) and/or dynamic RAM (DRAM), or cache memory. These memories 16, 36 may be configured to temporarily hold a limited amount of data received from a data sensor or subsystem, data and/or processor-executable code instructions that are requested from a non-volatile memory 16, 24, loaded to the memories 16 from the non-volatile memory 16, 24 in anticipation of future access based on a variety of factors, and/or intermediary processing data and/or processor-executable code instructions produced by the processors 14, 40 and temporarily stored for future quick access without being stored in non-volatile memory 16, 24. The memory interface 34 and the memory 36 may work in unison to allow the computing device 10 to load and retrieve data and processor-executable code on the memory 36.

The storage memory interface 20 and the storage memory 24 may work in unison to allow the computing device 10 to store data and processor-executable code on a non-volatile storage medium. The storage memory 24 may be configured much like an embodiment of the memory 16 in which the storage memory 24 may store the data or processor-executable code for access by one or more of the processors 14, 40. The storage memory 24, being non-volatile, may retain the information after the power of the computing device 10 has been shut off. When the power is turned back on and the computing device 10 reboots, the information stored on the storage memory 24 may be available to the computing device 10. The storage memory interface 20 may control access to the storage memory 24 and allow the processors 14, 40 to read data from and write data to the storage memory 24.

The power manager 28 may be configured to control power states of and/or power delivery to the components of the SoC 12. In some embodiments, the power manager 28 may be configured to signal power states to the components of the SoC 12 to prompt the components of the SoC 12 to transition to the signaled power states. In some embodiments, the power manager 28 may be configured to control amounts of power provided to the components of the SoC 12. For example, the power manager 28 may be configured to control connections between components of the SoC 12 and power rails (not shown). As another example, the power manager 28 may be configured to control amounts of power on power rails connected to the components of the SoC 12.

A clock controller 30 may be configured to control clock signals transmitted to the components of the SoC 12. In some embodiments, the clock controller 30 may be configured to signal clock states, such as gated or ungated, to components of the SoC 12 to prompt the components of the SoC 12 to transition to the clock state. For example, a component of the SoC 12 may transition to a gated clock state in response to receiving a gated clock state signal from the clock controller 30 by disconnecting from a clock signal and may transition to an ungated clock state in response to receiving an ungated clock state signal from the clock controller 30 by connecting to the clock signal. In some embodiments, the clock controller 30 may be configured to control clock signals to components of the SoC 12. For example, the clock controller 30 may disconnect a component of the SoC 12 from a clock signal to transition the component of the SoC 12 to a gated clock state and may connect the component of the SoC 12 to the clock signal to transition the component of the SoC 12 to an ungated clock state.

A processor interface 40 may enable components of the SoC 12, such as the processor 14 and/or the memory, to communicate with the processor 40. The processor interface 38 may provide and mange physical and logical connections between the components of the SoC 12 and the processor 40. The processor interface 38 may also manage communication between the components of the SoC 12 and the processor 40, such as by directing and/or allowing communications between transmitter and receiver pairs of the components of the SoC 12 and the processor 40 for a communication. The communications may include transmission of memory access commands, addresses, data, interrupt signals, state signals, notification signals, etc.

The interconnect 32 may be a communication fabric, such as a communication bus, configured to communicatively connect the components of the SoC 12. The interconnect 32 may transmit signals between the components of the SoC 12. In some embodiments, the interconnect 32 may be configured to control signals between the components of the SoC 12 by controlling timing and/or transmission paths of the signals.

Some or all of the components of the computing device 10 and/or the SoC 12 may be arranged differently and/or combined while still serving the functions of the various embodiments. The computing device 10 may not be limited to one of each of the components, and multiple instances of each component may be included in various configurations of the computing device

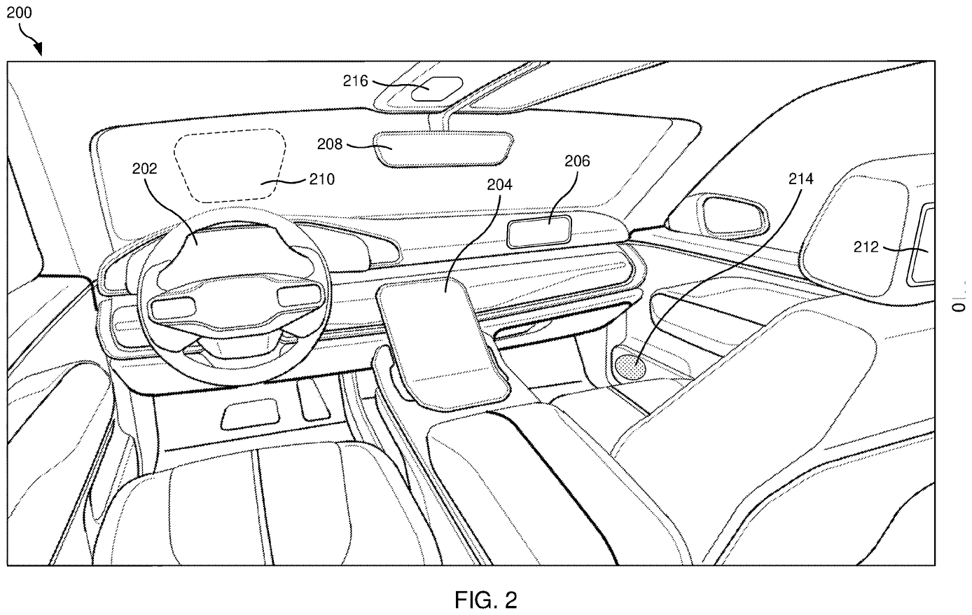

FIG. 2 illustrates an example multi-operating system (OS) architecture 200 in a vehicle context suitable for implementing various embodiments. With reference to FIGS. 1 and 2, the multi-OS architecture 200 may implement multiple applications for use in a vehicle on a host OS and multiple virtualized, guest OSes. For example, applications for generating, receiving, and/or outputting information using multiple visual display devices 202, 204, 206, 208, 210, 212, audio output devices 214 (e.g., speakers), and/or sensors 216 of the interior and/or exterior of a vehicle may be implemented on the host OS and multiple guest OSes.

An application for a main visual display, such as critical driving information presented to a driver of the vehicle via a driver dashboard display 202, may be implemented on a host OS. Other applications with less criticality than the main visual display or for less central functions to the operation of the vehicle than the main visual display may be implemented on multiple guest OSes. Other applications for implementation of functions using visual displays implemented on the multiple guest OSes may include applications for ancillary driving information (e.g., navigation information, driving safety information), communication information (e.g., cellular telephone communication information), vehicle system information and controls (e.g., vehicle system notifications, heating ventilation and air conditioning (HVAC) system controls, infotainment system controls, comfort system controls, environment system controls, driving mode system controls, etc.), etc. Generation, display, and control of ancillary driving information, communication information, vehicle system information and controls, etc. may be implemented on a guest OS and displayed via a center display 204, a front passenger display 206, a rearview mirror display 208, augmented reality and/or heads up display 210, a rear passenger display 212, etc.

Applications for implementation of functions using audio displays 206 implemented may be on multiple guest OSes. The applications for implementation of functions using the audio displays 206 may include applications for ancillary driving information (e.g., navigation information, driving safety information), communication information (e.g., cellular telephone communication information), vehicle system information and controls (e.g., vehicle system notifications, voice commands for HVAC system controls, infotainment system controls, comfort system controls, environment system controls, driving mode system controls, etc.), audio entertainment, noise cancellation, etc. The audio displays 214 may include speakers and/or microphones of the interior and/or exterior of the vehicle.

Applications for implementation of functions using sensors 216 may be on the multiple guest OSes. The applications for implementation of functions using sensors 216 may include applications for ancillary driving information (e.g., navigation information, driving safety information), communication information (e.g., vehicle to X (V2X) communication), vehicle system information and controls (e.g., HVAC system control, infotainment system control, comfort system control, environment system control, adaptive driving system control, automated driving control, etc.), etc. Sensors 216 may include electromagnetic radiation (e.g., visible light, infrared light, radio waves, laser light, etc.) emitters and/or detectors, pressure sensors, etc. of the interior and/or exterior of the vehicle.

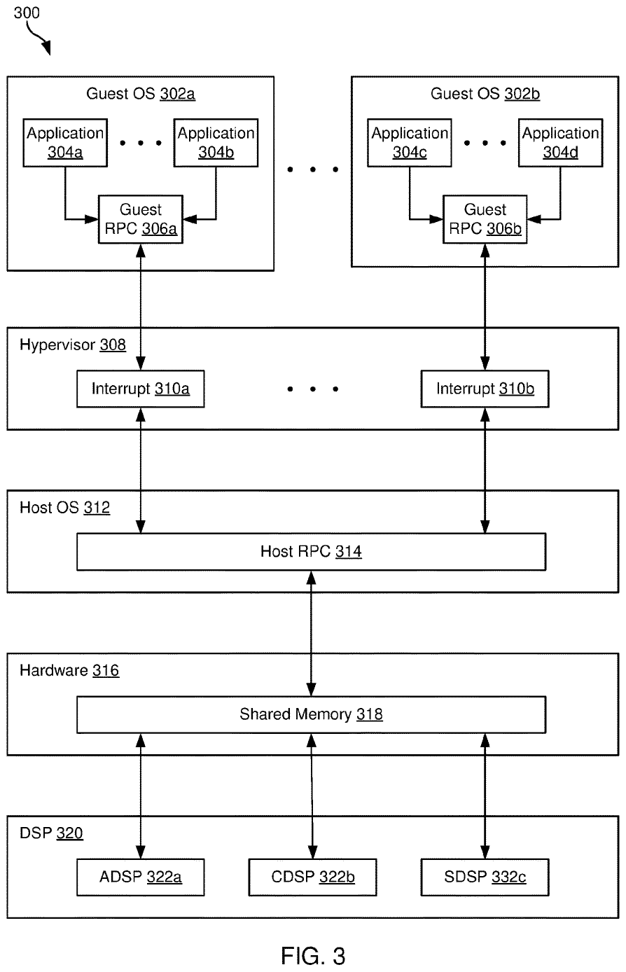

FIG. 3 illustrates an example remote procedure call (RPC) virtualization system 300 for a multi-OS architecture suitable for implementing various embodiments. With reference to FIGS. 1-3, the RPC virtualization system 300 may include any number and combination of virtualized guest OSes 302a, 302b, a hypervisor 308, a host OS 312, system hardware 316, and any number and combination of DSPs 322a, 322b, 322c (e.g., processor 40)(e.g., audio DSP (ADSP) 322a, computing DSP (CDSP) 322b, sensor DSP (SDSP) 322c). The virtualized guest OSes 302a, 302b, the hypervisor 308, and/or the host OS 312 may be implemented by a processor (not shown)(e.g., processor 14), such as a CPU.

The guest OSes 302a, 302b may each implement any number and combination of applications 304a, 304b, 304c, 304d. For example, each application 304a-304d may be implemented for a different function of a system (e.g., multi-OS architecture 200). Such functions may include system information gathering, generation, display, storage, analysis, security, system control generation, implementation, security, etc.

The RPC virtualization system 300 may enable the guest OSes 302a, 302b and the applications 304a-304d to offload work for implementing the functions to any number and combination of the DSPs 322a-322c via virtualized RPCs. To implement the functions of the applications 304a-304d, the guest OSes 302a, 302b may each implement a guest RPC module 306a, 306b. The applications 304a-304d may send RPC requests for implementing functions by one or more of the DSPs 322a-322c to the guest RPC modules 306a, 306b implemented on the same guest OSes 302a, 302b. The guest RPC modules 306a, 306b may virtualize the RPC requests to generate virtual RPC requests. RPC request virtualization by the guest RPC modules 306a, 306b may include storing the RPC request information to a shared memory 318 (e.g., memory 16, 36) of the hardware 316. Each guest OS 302a, 302b may be associated with a specific virtual queue in the shared memory 318 for storing RPC request information from the guest OSes 302a, 302b. RPC request virtualization by the guest RPC modules 306a, 306b may also include sending notifications of the RPC requests to the host OS 312 via the hypervisor 308.

In response to receiving the notification of the RPC requests, the hypervisor 308 may generate and send interrupts 310a, 310b to the host OS 312. The interrupts 310a, 310b may be configured to trigger the host OS 312 to respond to the RPC requests. Each interrupt 310a, 310b may be configured for a specific guest OS 302a, 302b. A host RPC module 314 may be implemented by the host OS 312 to handle the interrupts 310a, 310b and the RPC requests. In response to receiving the interrupts 310a, 310b, the host RPC module 314 may generate and send RPC requests to one or more of the DSPs 322a-322c based on information of the virtual RPC requests stored at the shared memory 318. For example, host RPC module 314 responding to an interrupt 310a, 310b for a specific guest OS 302a, 302b may retrieve the information of the virtual RPC requests from the virtual queue for the specific guest OS 302a, 302b at the shared memory 318.

In response to receiving the RPC requests from the host RPC module 314, the DSPs 322a-322c may implement the work of the RPC requests. The DSPs 322a-322c may implement the work based on information of the received RPC requests and/or retrieved from the shared memory 318. For example, the DSPs 322a-322cimplementing the work of the RPC requests may retrieve information of the RPC requests from the virtual queues for specific guest OS 302a, 302b, associated with the RPC requests, at the shared memory 318.

The DSPs 322a-322c may store results of the work send RPC results messages to the host OS 312. In response to receiving the RPC results messages at the host OS 312, the host RPC module 314 may generate and send a virtual RPC results messages to the guest OSes 302a, 302b via the hypervisor 308. Generating the virtual RPC results messages may include storing RPC results message information to the shared memory 318. For example, the host RPC module 314 may store RPC results message information to the virtual queues of the guest OSes 302a, 302b in the shared memory 318 to which the RPC results notifications are targeted.

In response to receiving the virtual RPC results messages, the hypervisor 308 may generate and send interrupts 310a, 310b to the guest OSes 302a, 302b. The interrupts 310a, 310b may be configured to trigger the guest OSes 302a, 302b to respond to the RPC results messages. Each interrupt 310a, 310b may be configured for a specific guest OS 302a, 302b. The guest RPC modules 306a, 306b, implemented by the guest OSes 302a, 302b, may be configured to handle the interrupts 310a, 310b and the RPC results messages. In response to receiving the interrupts 310a, 310b, the guest RPC modules 306a, 306b may generate and send RPC results messages to one or more of the applications 304a-304d based on information of the virtual RPC results messages stored at the shared memory 318. For example, the guest RPC modules 306a, 306b responding to the interrupts 310a, 310b for the specific guest OS 302a, 302b may retrieve the information of the virtual RPC results messages from the virtual queue for the specific guest OSes 302a, 302b at the shared memory 318.

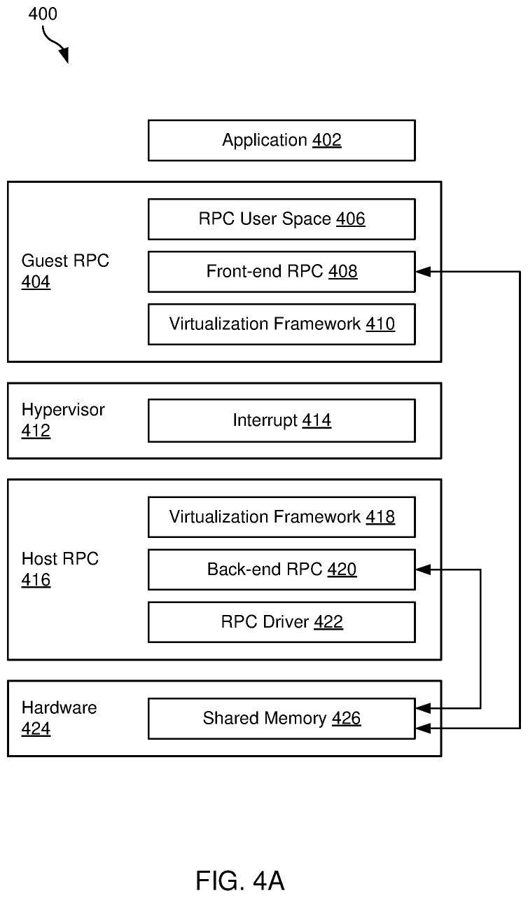

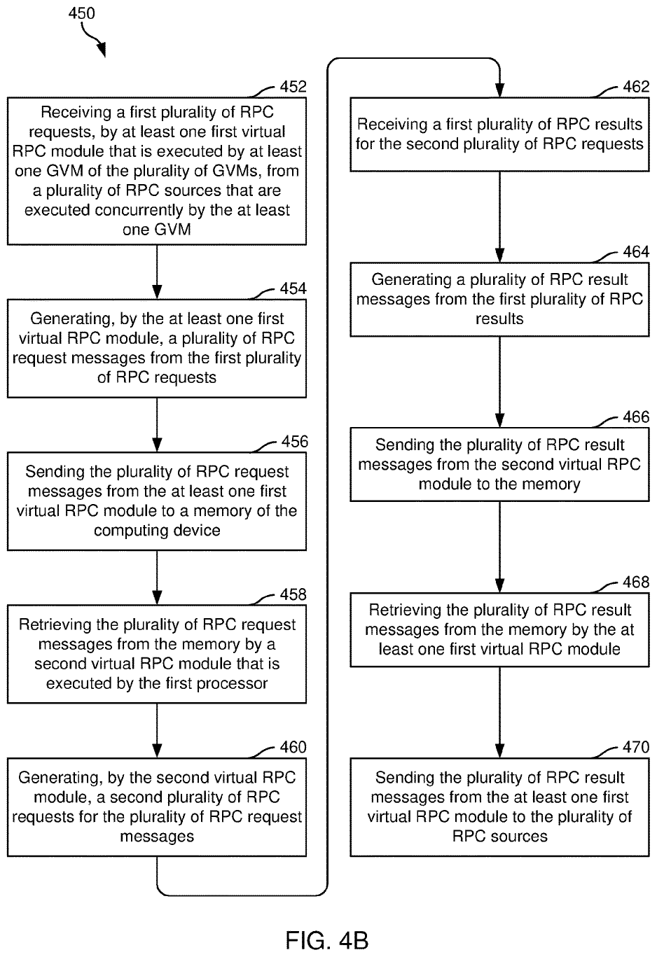

FIG. 4A illustrates an RPC virtualization system 400 (e.g., RPC virtualization system 300) suitable for implementing various embodiments. FIG. 4B illustrates a method 450 for RPC virtualization according to some embodiments. With reference to FIGS. 1-4B, the RPC virtualization system 400 may include an application 402 (e.g., application 304a-304d), a guest RPC module 404 (e.g., guest RPC module 306a, 306b), a hypervisor 412 (e.g., hypervisor 308), a host RPC module 416 (e.g., host RPC module 314), and hardware 424 (e.g., hardware 316). The method 450 may be implemented using any combination of the guest RPC module 404, the hypervisor 412, the host RPC module 416, and/or the hardware 424.

The guest RPC module 404 may include an RPC user space 406, a front-end RPC module 408, and a virtualization framework 410 (e.g., Virtio). The RPC user space 406 may provide APIs to the application 402 The APIs may be configured to enable the application 402 to execute on a single OS and/or a guest OS (e.g., guest OS 302a, 302b) without modification. The application 402 may call the RPC user space 406 directly. The application 402 may control parameters for RPC requests, such as buffer types and an application process attributes for implementing the RPC requests.

In response to an RPC request by the application 402, the RPC user space 406 may make the RPC request of the front-end RPC module 408. The front-end RPC module 408 may pack RPC request messages and send the RPC request messages to a back-end RPC module 420 via the virtualization framework 410. The front-end RPC module 408 may be configured to handle different requirement types of complicated AI modules, multiple applications 402, and/or guest OSes. The method 450 may include receiving a first plurality of RPC requests, by at least one first virtual RPC module (e.g., front-end RPC module 408) that is executed by at least one GVM of a plurality of GVMs, from a plurality of RPC sources (e.g., application 402) that are executed concurrently by the at least one GVM in block 452. In some embodiments, the first plurality of RPC requests may be received concurrently. In some embodiments, the first plurality of RPC requests may include a first RPC request from a first RPC source of the plurality of RPC sources and a second RPC request from a second RPC source of the plurality of RPC sources, in which the first RPC request and the second RPC request may be directed to a second processor of the computing device.

To pack the RPC request messages, the front-end RPC module 408 may check a buffer type and an application process attribute for the RPC request. The front-end RPC module 408 may support a buffer with an offset, an overlapping buffer, and a persistent buffer. The variable buffer support may increase the application performance, and account for a greater number of scenarios than when the system lacks variable buffer support. The method 450 may include generating, by the at least one first virtual RPC module (e.g., front-end RPC module 408), a plurality of RPC request messages from the first plurality of RPC requests in block 454.

In some embodiments, the first plurality of RPC requests may include a first RPC request and a second RPC request from a first RPC source of the plurality of RPC sources, in which the first RPC request may be directed to a second processor of the computing device and the second RPC request may be directed to a third processor of the computing device. In such embodiments, generating the second plurality of RPC requests for the plurality of RPC request messages in block 454 may include generating a third RPC request directed to the second processor and a fourth RPC request directed to the third processor.

In some embodiments, the plurality of RPC sources may include a first application and a second application and the first plurality of RPC requests may include a first RPC request from the first application and a second RPC request from the second application. In such embodiments, generating the second plurality of RPC requests for the plurality of RPC request messages may include generating a third RPC request directed to the second processor and a fourth RPC request directed to the second processor.

In some embodiments, the plurality of RPC sources may include a first application and a second application and the first plurality of RPC requests may include a first RPC request from the first application and a second RPC request from the second application, and generating the second plurality of RPC requests for the plurality of RPC request messages in block 454 may include generating a third RPC request from the first application and a fourth RPC request from the second application. Such embodiments may further include pushing the third RPC request to a first thread pool for the first application, and pushing the fourth RPC request to a second thread pool for the second application.

To send the packed RPC request messages, the front-end RPC module 408 may store the process attribute for each application 408 and requested DSP, and send this information to the back-end RPC module 420 during an opening request. The front-end RPC module 408 may create a transmit and receive virtual queue (e.g., Virtio virtqueue) for an associated guest OS in a shared memory 426 (e.g., memory 16, 36, shared memory 318) of the hardware 424. The front-end RPC module 408 may store information of the packed RPC request messages to the transmit virtual queue. The front-end RPC module 408 may send RPC request notifications to inform the back-end RPC module 420 of the packed RPC request messages. The method 450 may include sending the plurality of RPC request messages from the at least one first virtual RPC module (e.g., front-end RPC module 408) to a memory (e.g., shared memory 426) of a computing device (e.g., computing device 10) in block 456.

The hypervisor 412 may enable communications between the front-end RPC module 408 and the back-end RPC module 420. The hypervisor 412 may receive the RPC request notifications and may generate interrupts 414 specific to the guest OS to send to the back-end RPC module 420.

The host RPC module 416 may include a virtualization framework 418 (e.g., Virtio), the back-end RPC module 420, and an RPC driver 422. The back-end RPC module 420 may receive packed RPC request messages from the front-end RPC module 408. In response to receiving the interrupts 414, the back-end RPC module 420 may retrieve and unpack the packed RPC request messages. The back-end RPC module 420 may retrieve information of the packed RPC request messages from the transmit virtual queue in the shared memory 426 via the virtualization framework 418. The back-end RPC module 420 may retrieve the application process attributes and a requested DSP, check different buffer types for use of a transient buffer and/or a persistent buffer, as well as an overlap buffer, a buffer with offset, etc. The use of application process attributes and variable buffer types may enable multiple applications 402 and guest OSes to execute concurrently, and for multiple DSPs (not shown)(e.g., processor 40, DSPs 322a-322c) to implement RPC requests for an application 402. The method 450 may include retrieving the plurality of RPC request messages from the memory (e.g., shared memory 426) by a second virtual RPC module (e.g., back-end RPC module 420) that is executed by a first processor (e.g., processor 14) in block 458.

In some embodiments, the at least one GVM may include a first GVM and a second GVM, the plurality of RPC sources may include the first GVM and the second GVM and the first plurality of RPC requests may include a first RPC request from the first GVM and a second RPC request from the second GVM. In such embodiments, generating the plurality of RPC request messages from the first plurality of RPC requests in block 454 may include generating a first RPC request message from the first RPC request and a second RPC request message from the second RPC request. In such embodiments, sending the plurality of RPC request messages from the at least one first virtual RPC module to the memory in block 456 may include pushing the first RPC request message to a first queue for the first GVM and pushing the second RPC request message to a second queue for the second GVM. Further, in such embodiments, retrieving the plurality of RPC request messages from the memory by the second virtual RPC module in block 458 may include retrieving the first RPC request message from the first queue for the first GVM and retrieving the second RPC request message from the second queue for the second GVM.

In some embodiments, the at least one GVM may include a first GVM and a second GVM, the plurality of RPC sources may include the first GVM and the second GVM, the first plurality of RPC requests may include a first RPC request from the first GVM and a second RPC request from the second GVM, and the at least one first virtual RPC module may include a first virtual RPC module executed by the first GVM and a first virtual RPC module executed by the second GVM. In such embodiments, generating the plurality of RPC request messages from the first plurality of RPC requests in block 454 may include generating a first RPC request message from the first RPC request by the first virtual RPC module executed by the first GVM, and generating a second RPC request message from the second RPC request by the first virtual RPC module executed by the second GVM. In such embodiments, sending the plurality of RPC request messages from the at least one first virtual RPC module to the memory in block 456 may include sending the first RPC request message by the first virtual RPC module executed by the first GVM to the memory, and sending the second RPC request message by the first virtual RPC module executed by the second GVM to the memory. Such embodiment methods may further include sending a first RPC request notification for the first GVM from the first virtual RPC module executed by the first GVM to the second virtual RPC module and sending a second RPC request notification for the second GVM from the first virtual RPC module executed by the second GVM to the second virtual RPC module. In such embodiments, retrieving the plurality of RPC request messages from the memory by the second virtual RPC module in block 458 may include retrieving the first RPC request message from the memory in response to receiving the first RPC request notification, and retrieving the second RPC request message from the memory in response to receiving the second RPC request notification.

The method 450 may include generating, by the second virtual RPC module (e.g., back-end RPC module 420), a second plurality of RPC requests for the plurality of RPC request messages in block 460. The back-end RPC module 420 may send the unpacked RPC request messages, along with the information retrieved from the shared memory 426, to the RPC driver 422.

In some embodiments, generating the plurality of RPC request messages from the first plurality of RPC requests in block 454 may include generating the plurality of RPC request messages with data of the plurality of RPC request messages from a first buffer and a buffer attribute of the first buffer. In such embodiments, generating the second plurality of RPC requests from the plurality of RPC request messages in block 460 may include mapping a second buffer using the buffer attribute, storing the data of the plurality of RPC request messages to the second buffer, and generating the second plurality of RPC requests using the data of the plurality of RPC request messages from the second buffer.

In some embodiments, an application may specify using persistent buffers for RPC requests of the application. For such embodiments, a first persistent buffer and a second persistent buffer may be mapped for use by the application. Generating the plurality of RPC request messages with the data of the plurality of RPC request messages from the first buffer in block 454 may include generating at least one RPC request message for at least one RPC request of the application using at least one file descriptor for the data of the at least one RPC request message. In such embodiments, the data of the at least one RPC request message may be retrieved using the at least one file descriptor from the at least one RPC request message from the first persistent buffer, in block 458, and the data of the least one RPC request message may be stored to the second persistent buffer. Generating the second plurality of RPC requests from the plurality of RPC request messages, in block 460, may include generating at least one RPC request of the second plurality of RPC requests using the data of the at least one RPC request message from the second persistent buffer. The designated persistent buffers may be used for any application that specifies use of persistent buffers for RPC requests of the application. The persistent buffers may be mapped across multiple RPC requests for the application specifying use of persistent buffers. Other applications not specifying use of persistent buffers may use other means, such other buffers, to generate and retrieve RPC request messages.

Some embodiment methods may further include setting a process attribute of the plurality of RPC sources, in which generating the plurality of RPC request messages from the first plurality of RPC requests in block 454 may include generating the plurality of RPC request messages from the first plurality of RPC requests based on the process attribute. Such embodiments may further include setting the process attribute using the process attribute from the plurality of RPC request messages for implementing the second plurality of RPC requests.

In response to receiving the unpacked RPC request messages, the RPC driver 422 may send the unpacked RPC request messages to the DSPs via the shared memory 426. The RPC driver 422 may construct the RPC request messages according to protocols with the DSPs and communicate the RPC request messages with the DSP via the shared memory 426. The RPC driver 422 may create thread pools for each application process and push the RPC request messages to the associated thread pool. The DSPs may implement the work of the RPC request messages and provide the RPC results to the RPC driver 422. In response to receiving the RPC results, the RPC driver 422 may forward the RPC results to the back-end RPC module 420. The method 450 may include receiving (by, for example, the back-end RPC module 420) a first plurality of RPC results for the second plurality of RPC requests in block 462.

In response to the receiving the RPC results, the back-end RPC module 420 may send RPC return messages, or RPC result messages, to the front-end RPC module 408 via the receive virtual queue. In the process of sending the RPC return messages, the back-end RPC module 402 may check for unused persistent buffers in the shared memory 426 and remove them, retrieve more data, such as file descriptors of persistent data and error detecting code (e.g., cyclic redundancy check (CRC)) from the DSPs, and pack the RPC return messages. The back-end RPC module 420 may push the packed RPC return messages to the receive virtual queue for the targeted guest OS and send RPC return notifications to the front-end RPC module 408. The hypervisor 412, enabling communication between the back-end RPC module 420 and the front-end RPC module 408, may generate interrupts 414 specific to the guest OS, in response to the RPC return notifications, to send to the front-end RPC module 408. The method 450 may include generating (by, for example, the back-end RPC module 420) a plurality of RPC result messages from the first plurality of RPC results in block 464. The method 450 may include, sending the plurality of RPC result messages from the second virtual RPC module (e.g., back-end RPC module 420) to the memory (e.g., shared memory 426) in block 466.

In response to the front-end RPC module 408 receiving the interrupts 414, the front-end RPC module 408 may retrieve and unpack the RPC return message from the receive virtual queue. The front-end RPC module 408 may send the RPC return message to RPC user space 406. The front-end RPC module 408 may handle unused persistent buffers for the RPC return message and other aspects of the RPC return message, such as extended functions like cyclic redundancy check (CRC) checking, profiling data, etc., and copy RPC result from the receive virtual queue to RPC user space 406. The method 450 may include retrieving the plurality of RPC result messages from the memory (e.g., shared memory 426) by the at least one first virtual RPC module (e.g., front-end RPC module 408) in block 468. The method 450 may include sending the plurality of RPC result messages from the at least one first virtual RPC module (e.g., front-end RPC module 408) to the plurality of RPC sources (e.g., application 402) in block 470.

In some embodiments, the at least one GVM may include a first GVM and a second GVM, the plurality of RPC sources may include the first GVM and the second GVM, the first plurality of RPC results may include a first RPC result for the first GVM and a second RPC result for the second GVM, and the at least one first virtual RPC module may include a first virtual RPC module executed by the first GVM and a first virtual RPC module executed by the second GVM. In such embodiments, generating the plurality of RPC result messages from the first plurality of RPC results in block 454 may include generating a first RPC result message from the first RPC result and a second RPC result message from the second RPC result. In such embodiments, sending the plurality of RPC result messages from the second virtual RPC module to the memory in block 466 may include pushing the first RPC result message to a first queue of the first GVM and pushing the second RPC result message to a second queue of the second GVM. In such embodiments, retrieving the plurality of RPC result messages from the memory by the at least one first virtual RPC module in block 468 may include retrieving the first RPC result message from the first queue of the first GVM by the first virtual RPC module executed by the first GVM, and retrieving the second RPC result message from the second queue of the second GVM by the first virtual RPC module executed by the second GVM.

In some embodiments, the at least one GVM may include a first GVM and a second GVM, and the plurality of RPC sources may include the first GVM and the second GVM, the at least one first virtual RPC module may include a first virtual RPC module executed by the first GVM and a first virtual RPC module executed by the second GVM, and the first plurality of RPC results may include a first RPC result for the first GVM and a second RPC result for the second GVM. In such embodiments, generating the plurality of RPC result messages from the first plurality of RPC results in block 454 may include generating a first RPC result message from the first RPC result and a second RPC result message from the second RPC result. In such embodiments, sending the plurality of RPC result messages from the second virtual RPC module to the memory in block 466 may include sending the first RPC result message and the second RPC result message to the memory. In such embodiments, the method further include sending a first RPC result notification for the first GVM from the second virtual RPC module to the first virtual RPC module executed by the first GVM and a second RPC result notification for the second GVM from the second virtual RPC module to the first virtual RPC module executed by the second GVM. In such embodiments, retrieving the plurality of RPC result messages from the memory by the at least one first virtual RPC module in block 468 may include retrieving, by the first virtual RPC module executed by the first GVM, the first RPC result message from the memory in response to receiving the first RPC result notification, and retrieving, the first virtual RPC module executed by the second GVM, the second RPC result message from the memory in response to receiving the second RPC result notification.

For an application specifying use of persistent buffers, the persistent buffers may also be used for returning the RPC results to the application. In some embodiments, generating the plurality of RPC result messages from the first plurality of RPC results in block 464 may include generating a first RPC result message using at least one file descriptor for a first RPC result, for an RPC request from the application, from a first persistent buffer. In such embodiments, retrieving the plurality of RPC result messages from the memory by the at least one first virtual RPC module in block 468 may include retrieving the at least one file descriptor for the first RPC result from a second persistent buffer. Such embodiment methods may further include freeing the first persistent buffer storing the at least one file descriptor for the first plurality of RPC results, and freeing the second persistent buffer storing the at least one file descriptor for the first RPC result.

In some embodiments, the plurality of RPC sources may include one or more of a plurality of guest virtual machines, a plurality of applications running on a guest virtual machine, or at least one application running on each of a plurality of guest virtual machines.

Examples described herein provide hypervisor and Virtio based communication for RPC virtualization communication between the guest RPC module 404 and the host RPC module 416. The described examples are not exhaustive and nonlimiting, and one of skill in the art would realize that the hypervisor and Virtio based communication may be replaced with other means for different systems.

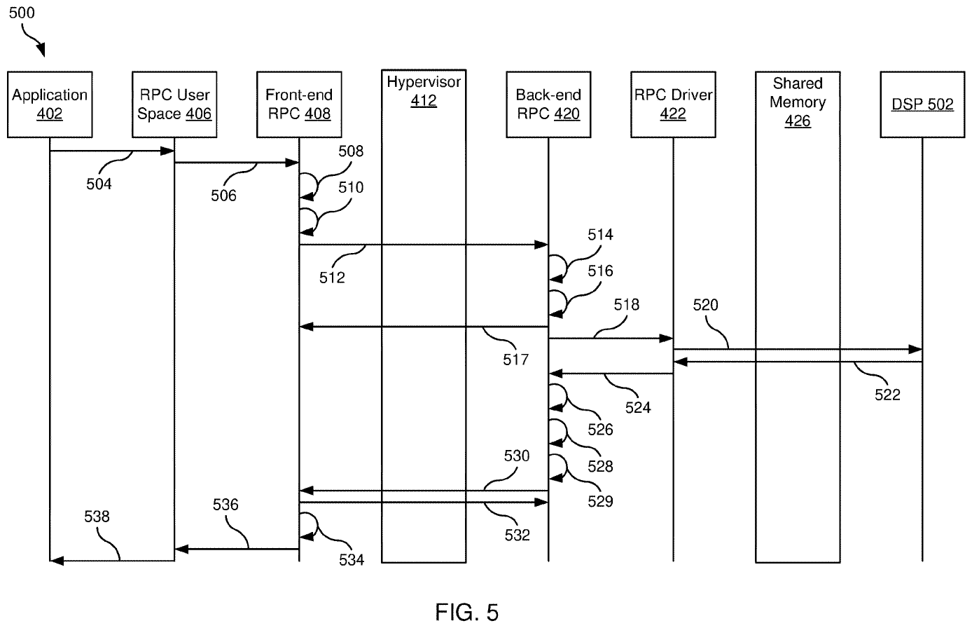

FIG. 5 is a message flow diagram illustrating an RPC virtualization system 500 (e.g., the RPC virtualization system 300, 400) suitable for implementing various embodiments. With reference to FIGS. 1-5, the RPC virtualization system 500 may include the application 402, the RPC user space 406, the front-end RPC module 408, the hypervisor 412, the back-end RPC module 420, the RPC driver 422, the shared memory 426, and a DSP 502 (e.g., processor 40, DSP 322a, 322b, 322c).

The application 402 may generate and send an RPC request 504. Multiple applications 402 on one or more GVMs (not shown)(e.g., guest OS 302a, 302b) may generate and send RPC requests concurrently. The multiple RPC requests may be directed to any number and combination of DSPs 502 concurrently. For example, multiple RPC requests may be directed to the same DSP 502 concurrently and/or to different DSPs 502 concurrently. A persistent buffer in the shared memory 426 may be shared across multiple RPC requests. The RPC requests may be configured to enable requests for a session attribute setting, offloading non-signature object to limited regions of the DSPs 502, unsigned setting, async communication between a CPU (not shown)(e.g., processor 14) and the DSPs 502, error code checks (e.g., CRC checks) for buffers, profiling data, etc.

The RPC user space 406 may receive the RPC request and may generate and send an input/output control (Ioctl) command 506. The Ioctl command may be configured to enable commands and parameters for RPC requests having application process attributes and using the persistent buffer.

The front-end RPC module 408 may receive the Ioctl command, and pack an RPC request message in operation 508. To pack the RPC request message 508, the front-end RPC module 408 may copy buffer data for the application 402 or find the buffer data for the application 402 via a file descriptor, and check a buffer overlap, a buffer offset, and a restructure format. The front-end RPC module 408 may also set a process attribute of the application 402, pack the buffer data, a buffer attribute, the file descriptor, and reserve space for asynchronous, error check, and other data in the shared memory 426.

The front-end RPC module 408 may push the RPC request message to a virtual transmit queue in operation 510. The front-end RPC module 408 may push the RPC request message to the virtual transmit queue 510 for the associated GVM in the shared memory 426.

The front-end RPC module 408 may generate and send an RPC request notification 512. The RPC request notification may be configured to notify the back-end RPC module 420 to receive the RPC request message. The RPC request notification may include an interrupt associated with GVM from which the RPC request originates. In some embodiments, the hypervisor 412 may enable sending RPC request notification 512. For example, the hypervisor 412 may receive RPC request notification and generate and send the interrupt for the associated GVM to the back-end RPC module 420.

The back-end RPC module 420 may receive the RPC request notification and retrieve the RPC request message in operation 514 from the transmit virtual queue in the shared memory 426. In some embodiments, the RPC request notification may include receiving the interrupt sent by the hypervisor 412 in response to the RPC request notification. The back-end RPC module 420 may identify the transmit virtual queue associated with a GVM from which to retrieve the RPC request message that is the same as the GVM associated with the received RPC request notification and/or interrupt. Retrieving the RPC request message, the back-end RPC module 420 may check and set process attribute, check a buffer type, a restructure format, overlap buffers, map buffers with the same attributes as the front-end RPC module 408, and handle a buffer offset. For a persistent buffer type, the back-end RPC module 420 may retrieve data of the buffer via a file descriptor, and keep a mapping of the persistent buffer across RPCs.

The back-end RPC module 420 may push an RPC request for the retrieved RPC request message to a thread pool for the GVM and/or application 402 from which the RPC request originates in operation 516. The back-end RPC module 420 may initiate thread pools for each GVM and/or application 402 and push RPC requests to thread pools associated with the same GVM and/or application as the RPC request.

The back-end RPC module 420 may free the transmit virtual queue in the shared memory 426 in communication 517 in response to the data from the transmit virtual queue being retrieved. The data from the transmit virtual queue may be free to open space for subsequent RPC requests in response to the data being used by the back-end RPC module 420.

The back-end RPC module 420 may generate and send an RPC request 518, which may be received by the RPC driver 422. The RPC request generated by the back-end RPC module 420 may be representative of the RPC requests generated by the application 402 based on using the RPC request information pushed to the transmit queue by the front-end RPC module 408 and retrieved from the transmit queue by the back-end RPC module 420. As such, the RPC driver 422 may be unaware of the virtualization of the RPC request and may handle the RPC request as if received from the application 402. The RPC driver 422 may generate and send an RPC request message 520.

The DSP 502 receive the RPC request message from the RPC driver 422, execute work of the RPC request message, and store the results of the work to the shared memory 426. The DSP 502 may generate and send RPC results 522, which may be received by the RPC driver 422. The RPC driver 422 may generate and send an RPC results message 524.

The back-end RPC module 420 may receive the RPC results message and copy data of the RPC results message from buffers in the shared memory 426 in operation 526. The data of the RPC results message may include a file descriptor, error check data, and other data. The back-end RPC module 420 may check and free the buffers in the shared memory 426 in operation 528. For example, the back-end RPC module 420 may copy the data from a persistent buffer used across RPC requests. The back-end RPC module 420 may copy the data to the RPC results message. The back-end RPC module 420 may push the RPC results message to a receive virtual queue in the shared memory 426 in operation 529. The receive virtual queue may be associated with the GVM from which the RPC request originates.

The back-end RPC module 420 may generate and send an RPC results notification 530. The RPC results notification may be configured to notify the front-end RPC module 408 to receive the RPC results message. The front-end RPC module 408 may receive the RPC results notification and may respond to the RPC results notification by sending a receipt acknowledgement 532. The receipt acknowledgement may include an interrupt associated with GVM from which the RPC request originates. In some embodiments, the hypervisor 412 may enable sending receipt acknowledgement 532. For example, the hypervisor 412 may receive the receipt acknowledgement and generate and send the interrupt for the associated GVM to the front-end RPC module 408.

The front-end RPC module 408 may retrieve the RPC results message in operation 534 from the receive virtual queue in the shared memory 426. The front-end RPC module 408 may identify the receive virtual queue associated with a GVM from which to retrieve the RPC results message that is the same as the GVM from which the RPC originates. Retrieving the RPC results message, the front-end RPC module 408 may check and copy data of the RPC results message from buffers in the shared memory 426 in operation 526. The data of the RPC results message may include a file descriptor, error check data, profiling data, and other data. The front-end RPC module 408 may send the RPC results message 536 to the application 402 via the RPC user space 406, which forwards the RPC results message 536.

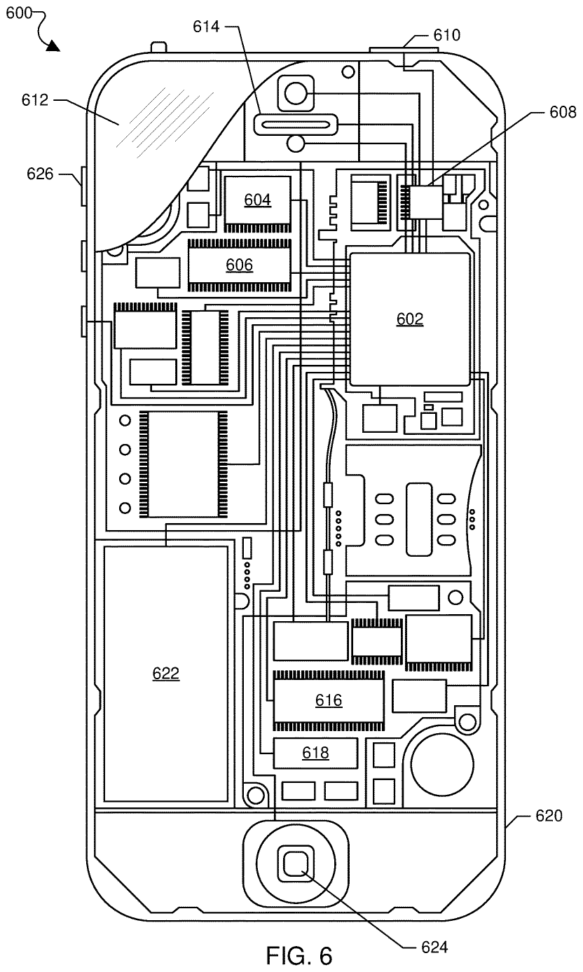

A system in accordance with the various embodiments (including, but not limited to, embodiments described above with reference to FIGS. 1-5) may be implemented in a wide variety of computing systems including mobile computing devices, an example of which suitable for use with the various embodiments is illustrated in FIG. 6. The mobile computing device 600 may include a processor 602 coupled to a touchscreen controller 604 and an internal memory 606. The processor 602 may be one or more multicore integrated circuits designated for general or specific processing tasks. The internal memory 606 may be volatile or non-volatile memory, and may also be secure and/or encrypted memory, or unsecure and/or unencrypted memory, or any combination thereof. Examples of memory types that can be leveraged include but are not limited to DDR, Low-Power DDR (LPDDR), Graphics DDR (GDDR), WIDEIO, RAM, Static RAM (SRAM), Dynamic RAM (DRAM), Parameter RAM (P-RAM), Resistive RAM (R-RAM), Magnetoresistive RAM (M-RAM), Spin-Transfer Torque RAM (STT-RAM), and embedded DRAM.

The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the mobile computing device 600 need not have touch screen capability.

The mobile computing device 600 may have one or more radio signal transceivers 608 (e.g., Peanut, Bluetooth, ZigBee, Wi-Fi, RF radio) and antennae 610, for sending and receiving communications, coupled to each other and/or to the processor 602. The transceivers 608 and antennae 610 may be used with the above-mentioned circuitry to implement the various wireless transmission protocol stacks and interfaces. The mobile computing device 600 may include a cellular network wireless modem chip 616 that enables communication via a cellular network and is coupled to the processor.

The mobile computing device 600 may include a peripheral device connection interface 618 coupled to the processor 602. The peripheral device connection interface 618 may be singularly configured to accept one type of connection, or may be configured to accept various types of physical and communication connections, common or proprietary, such as Universal Serial Bus (USB), Fire Wire, Thunderbolt, or PCIe. The peripheral device connection interface 618 may also be coupled to a similarly configured peripheral device connection port (not shown).

The mobile computing device 600 may also include speakers 614 for providing audio outputs. The mobile computing device 600 may also include a housing 620, constructed of a plastic, metal, or a combination of materials, for containing all or some of the components described herein. The mobile computing device 600 may include a power source 622 coupled to the processor 602, such as a disposable or rechargeable battery. The rechargeable battery may also be coupled to the peripheral device connection port to receive a charging current from a source external to the mobile computing device 600. The mobile computing device 600 may also include a physical button 624 for receiving user inputs. The mobile computing device 600 may also include a power button 626 for turning the mobile computing device 600 on and off.

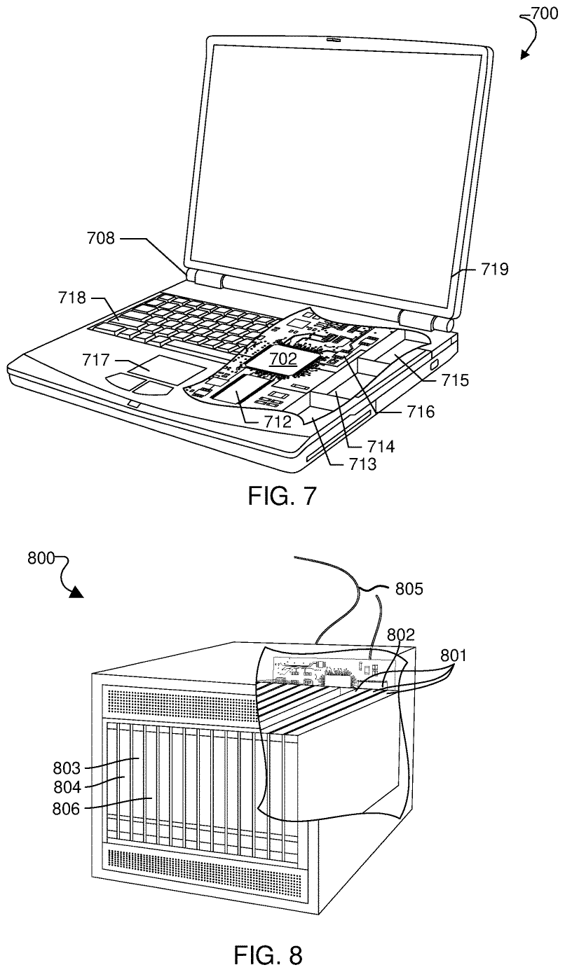

A system in accordance with the various embodiments (including, but not limited to, embodiments described above with reference to FIGS. 1-5) may be implemented in a wide variety of computing systems include a laptop computer 700 an example of which is illustrated in FIG. 7. Many laptop computers include a touchpad touch surface 717 that serves as the computer's pointing device, and thus may receive drag, scroll, and flick gestures similar to those implemented on computing devices equipped with a touch screen display and described above. A laptop computer 700 will typically include a processor 702 coupled to volatile memory 712 and a large capacity nonvolatile memory, such as a disk drive 713 of Flash memory. Additionally, the computer 700 may have one or more antenna 708 for sending and receiving electromagnetic radiation that may be connected to a wireless data link and/or cellular telephone transceiver 716 coupled to the processor 702. The computer 700 may also include a floppy disc drive 714 and a compact disc (CD) drive 715 coupled to the processor 702. In a notebook configuration, the computer housing includes the touchpad 717, the keyboard 718, and the display 719 all coupled to the processor 702. Other configurations of the computing device may include a computer mouse or trackball coupled to the processor (e.g., via a USB input) as are well known, which may also be used in conjunction with the various embodiments.

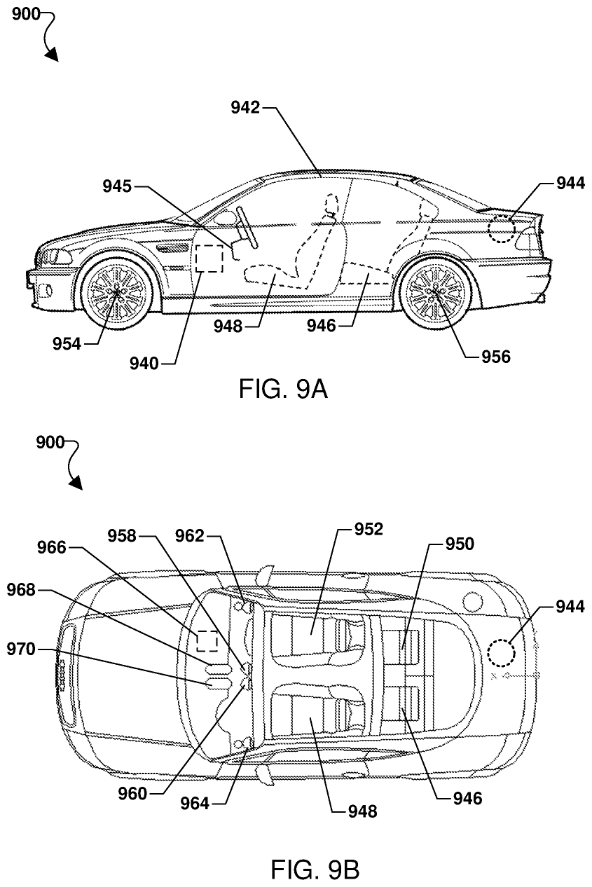

A system in accordance with the various embodiments (including, but not limited to, embodiments described above with reference to FIGS. 1-5) may also be implemented in fixed computing systems, such as any of a variety of commercially available servers. An example server 800 is illustrated in FIG. 8. Such a server 800 typically includes one or more multicore processor assemblies 801 coupled to volatile memory 802 and a large capacity nonvolatile memory, such as a disk drive 804. As illustrated in FIG. 8, multicore processor assemblies 801 may be added to the server 800 by inserting them into the racks of the assembly. The server 800 may also include a floppy disc drive, compact disc (CD) or digital versatile disc (DVD) disc drive 806 coupled to the processor 801. The server 800 may also include network access ports 803 coupled to the multicore processor assemblies 801 for establishing network interface connections with a network 805, such as a local area network coupled to other broadcast system computers and servers, the Internet, the public switched telephone network, and/or a cellular data network (e.g., CDMA, TDMA, GSM, PCS, 3G, 4G, LTE, 5G or any other type of cellular data network).

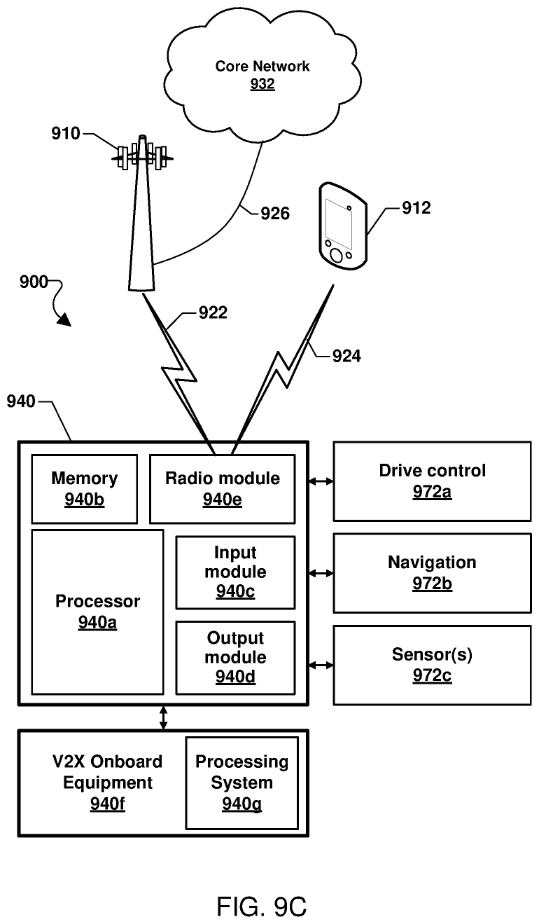

Methods and devices for implementing such methods in accordance with the various embodiments (including, but not limited to, embodiments described above with reference to FIGS. 1-5) may be implemented in a wide variety of computing systems including an embedded vehicle computing system 900 an example of which is illustrated in FIGS. 9A-9C. An embedded vehicle computing system 900 may include a vehicle control unit 940, such as an ECU, which may include a processor, such as a CPU, an AI processor, etc. The embedded vehicle computing system 900 may include a plurality of sensors 942-970, including satellite geopositioning system receivers 942, accelerometers 944, occupancy sensors 946, 948, 950, 952, tire pressure sensors 954, 956, cameras 958, 960, microphones 962, 964, impact sensors 966, radar 968, and LiDAR 970.

The plurality of sensors 942-970, disposed in or on the vehicle, may be used for various purposes, such as autonomous and semi-autonomous navigation and control, crash avoidance, position determination, etc., as well to provide sensor data regarding objects and people in or on the vehicle. The sensors 942-970 may include one or more of a wide variety of sensors capable of detecting a variety of information useful for navigation and collision avoidance. Each of the sensors 942-970 may be in wired or wireless communication with a control unit 940, as well as with each other. In particular, the sensors may include one or more cameras 958, 960 or other optical sensors or photo optic sensors. The sensors may further include other types of object detection and ranging sensors, such as radar 968, LiDAR 970, IR sensors, and ultrasonic sensors. The sensors may further include tire pressure sensors 954, 956, humidity sensors, temperature sensors, satellite geopositioning sensors 942, control input sensors 945, accelerometers 944, vibration sensors, gyroscopes, gravimeters, impact sensors 966, force meters, stress meters, strain sensors, fluid sensors, chemical sensors, gas content analyzers, pH sensors, radiation sensors, Geiger counters, neutron detectors, biological material sensors, microphones 962, 964, occupancy sensors 946, 948, 950, 952, proximity sensors, and other sensors.

The vehicle control unit 940 may include one or more processors configured with processor-executable instructions to perform navigation and collision avoidance operations using information received from various sensors, particularly the cameras 958, 960. In some embodiments, the control unit 940 may supplement the processing of camera images using distance and relative position (e.g., relative bearing angle) that may be obtained from radar 968 and/or LiDAR 970 sensors. The control unit 940 may further be configured to control steering, breaking and speed of the vehicle when operating in an autonomous or semi-autonomous mode using information regarding other vehicles determined using various embodiments. The vehicle control unit 940 may include one or more processors configured with processor-executable instructions to receive information from the sensors 942-970 and to perform operations using such information as further described herein. In various embodiments, the vehicle control unit 940 may include, be a component of, or communicate with V2X onboard equipment of the vehicle.

FIG. 9C is a component block diagram illustrating the embedded vehicle computing system 900 including components and support systems suitable for implementing various embodiments. The embedded vehicle computing system 900 may include the control unit 940, which may include various circuits and devices used to control the operation of the vehicle. The control unit 940 may include a processor 940a, such as a CPU, an AI processor, etc., a memory 940b, an input module 940c, an output module 940d, and a radio module 940e. The control unit 940 may be coupled to and configured to control drive control components 972a, navigation components 972b, and one or more sensors 972c of the embedded vehicle computing system 900. The control unit 940 may communicate with V2X onboard equipment 940f. The processor 940a may be configured with processor-executable instructions to control maneuvering, navigation, and/or other operations of the vehicle, including operations of various embodiments, including gathering and analyzing real-world autonomous vehicle run data gathered from the sensors 972c. The processor 940a may be coupled to the memory 940b. The V2X onboard equipment 940f may include one or more processors 940g configured with processor-executable instructions to perform various operations of various embodiments, including communicating real-world autonomous vehicle run data gathered from the sensors 972c between the embedded vehicle computing system 940 and a wireless communication device 912 and/or the computing device on a communication network (e.g., a core network 932) via the radio module 940e.

The radio module 940e may be configured for wireless communication. The radio module 940e may exchange signals (e.g., command signals for controlling maneuvering, signals from navigation facilities, data signals, etc.) via a communication link 922 with a network transceiver (e.g., the base station 910), and may provide the signals to the processor 940a, 940g and/or the navigation unit 972b. In some embodiments, the radio module 940e may enable the embedded vehicle computing system 900 to communicate with a wireless communication device 912 through the wireless communication link 924. The wireless communication link 924 may be a bidirectional or unidirectional communication link, and may use one or more communication protocols.

The input module 940c may receive sensor data from one or more vehicle sensors 972c as well as electronic signals from other components, including the drive control components 972a and the navigation components 972b. The output module 940d may communicate with or activate various components of the embedded vehicle computing system 900, including the drive control components 972a, the navigation components 972b, and the sensor(s) 972c.

The control unit 940 may be coupled to the drive control components 972a to control physical elements of the vehicle related to maneuvering and navigation of the vehicle, such as the engine, motors, throttles, steering elements, flight control elements, braking or deceleration elements, and the like. The drive control components 972a may also include components that control other devices of the vehicle, including interior environment controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 940 may be coupled to the navigation components 972b, and may receive data from the navigation components 972b and be configured to use such data to determine the present position and orientation of the vehicle, as well as an appropriate course toward a destination. The navigation components 972b may include or be coupled to a global navigation satellite system (GNSS) receiver system (e.g., one or more Global Positioning System (GPS) receivers) enabling the embedded vehicle computing system 900 to determine its current position using GNSS signals. Alternatively, or in addition, the navigation components 972b may include radio navigation receivers for receiving navigation beacons or other signals from radio nodes, such as Wi-Fi access points, cellular network sites, radio station, remote computing devices, other vehicles, etc. Through control of the drive control elements 972a, the processor 940a may control the vehicle to navigate and maneuver. The processor 940a, 940g and/or the navigation components 972b may be configured to communicate with a network element such as a server in a communication network (e.g., a core network 932) via the wireless communication link 922, 926 to receive commands to control maneuvering, receive data useful in navigation, provide real-time position reports, etc.

The control unit 940 may be coupled to one or more sensors 972c. The sensor(s) 972c may include the sensors 942-970 as described, and may the configured to provide a variety of data to the processor 940a, 940g.

While the control unit 940 is described as including separate components, in some embodiments some or all of the components (e.g., the processor 940a, the memory 940b, the input module 940c, the output module 940d, and the radio module 940e) may be integrated in a single device or module, such as an SoC processing device. Such an SoC processing device may be configured for use in vehicles and be configured, such as with processor-executable instructions executing in the processor 940a, to perform operations of navigation and collision avoidance.

Implementation examples are described in the following paragraphs. While some of the following implementation examples are described in terms of example systems, devices, or methods, further example implementations may include: the example systems or devices discussed in the following paragraphs implemented as a method executing operations of the example systems or devices, the example systems, devices, or methods discussed in the following paragraphs implemented by a computing device comprising a processing device configured with processing device-executable instructions to perform operations of the example systems, devices, or methods; a computing device including means for performing functions of the example systems, devices, or methods; and the example systems, devices, or methods discussed in the following paragraphs implemented as a non-transitory processor-readable storage medium having stored thereon processor-executable instructions configured to cause a processor of a computing device to perform the operations of the example systems, devices, or methods.

Example 1. A method executing in a first processor of a computing device of implementing remote procedure calls (RPCs), in which the first processor is configured to execute a plurality of guest virtual machines (GVMs) in parallel, the method including receiving a first plurality of RPC requests, by at least one first virtual RPC module that is executed by at least one GVM of the plurality of GVMs, from a plurality of RPC sources that are executed concurrently by the at least one GVM, generating, by the at least one first virtual RPC module, a plurality of RPC request messages from the first plurality of RPC requests, sending the plurality of RPC request messages from the at least one first virtual RPC module to a memory of the computing device, retrieving the plurality of RPC request messages from the memory by a second virtual RPC module that is executed by the first processor, and generating, by the second virtual RPC module, a second plurality of RPC requests for the plurality of RPC request messages.

Example 2. The method of example 1, in which receiving the first plurality of RPC requests includes receiving the first plurality of RPC requests concurrently.

Example 3. The method of any of examples 1 or 2, in which the first plurality of RPC requests includes a first RPC request and a second RPC request from a first RPC source of the plurality of RPC sources, the first RPC request is directed to a second processor of the computing device and the second RPC request is directed to a third processor of the computing device, and generating the second plurality of RPC requests for the plurality of RPC request messages includes generating a third RPC request directed to the second processor and a fourth RPC request directed to the third processor.

Example 4. The method of any of examples 1 or 2, in which the first plurality of RPC requests includes a first RPC request from a first RPC source of the plurality of RPC sources and a second RPC request from a second RPC source of the plurality of RPC sources, the first RPC request and the second RPC request are directed to a second processor of the computing device, and generating the second plurality of RPC requests for the plurality of RPC request messages includes generating a third RPC request directed to the second processor and a fourth RPC request directed to the second processor.

Example 5. The method of any of examples 1-4, in which the at least one GVM includes a first GVM and a second GVM, the plurality of RPC sources includes the first GVM and the second GVM and the first plurality of RPC requests includes a first RPC request from the first GVM and a second RPC request from the second GVM, generating the plurality of RPC request messages from the first plurality of RPC requests includes generating a first RPC request message from the first RPC request and a second RPC request message from the second RPC request, sending the plurality of RPC request messages from the at least one first virtual RPC module to the memory includes pushing the first RPC request message to a first queue for the first GVM and pushing the second RPC request message to a second queue for the second GVM, and retrieving the plurality of RPC request messages from the memory by the second virtual RPC module includes retrieving the first RPC request message from the first queue for the first GVM and retrieving the second RPC request message from the second queue for the second GVM.

Example 6. The method of any of examples 1-4, in which the at least one GVM includes a first GVM and a second GVM, the plurality of RPC sources includes the first GVM and the second GVM, the first plurality of RPC requests includes a first RPC request from the first GVM and a second RPC request from the second GVM, and the at least one first virtual RPC module includes a first virtual RPC module executed by the first GVM and a first virtual RPC module executed by the second GVM, generating the plurality of RPC request messages from the first plurality of RPC requests includes generating a first RPC request message from the first RPC request by the first virtual RPC module executed by the first GVM, and generating a second RPC request message from the second RPC request by the first virtual RPC module executed by the second GVM, and sending the plurality of RPC request messages from the at least one first virtual RPC module to the memory includes sending the first RPC request message by the first virtual RPC module executed by the first GVM to the memory, and sending the second RPC request message by the first virtual RPC module executed by the second GVM to the memory, and the method further includes sending a first RPC request notification for the first GVM from the first virtual RPC module executed by the first GVM to the second virtual RPC module, and sending a second RPC request notification for the second GVM from the first virtual RPC module executed by the second GVM to the second virtual RPC module, in which retrieving the plurality of RPC request messages from the memory by the second virtual RPC module includes retrieving the first RPC request message from the memory in response to receiving the first RPC request notification, and retrieving the second RPC request message from the memory in response to receiving the second RPC request notification.

Example 7. The method of any of claim 1-6, in which the plurality of RPC sources includes a first application and a second application and the first plurality of RPC requests includes a first RPC request from the first application and a second RPC request from the second application, and generating the second plurality of RPC requests for the plurality of RPC request messages includes generating a third RPC request from the first application and a fourth RPC request from the second application, the method further includes pushing the third RPC request to a first thread pool for the first application, and pushing the fourth RPC request to a second thread pool for the second application.

Example 8. The method of any of claims 1-7, in which generating the plurality of RPC request messages from the first plurality of RPC requests includes generating the plurality of RPC request messages with data of the plurality of RPC request messages from a first buffer and a buffer attribute of the first buffer, and generating the second plurality of RPC requests from the plurality of RPC request messages includes mapping a second buffer using the buffer attribute, storing the data of the plurality of RPC request messages to the second buffer, and generating the second plurality of RPC requests using the data of the plurality of RPC request messages from the second buffer.

Example 9. The method of any of examples 1-8, in which: the first plurality of RPC requests includes at least one RPC request from a first RPC source of the plurality of RPC sources; generating the plurality of RPC request messages from the first plurality of RPC requests includes generating at least one RPC request message using at least one file descriptor from a first persistent buffer for the data of the at least one RPC request message; and the method further includes: mapping a second persistent buffer for use by the first RPC source; retrieving the data of the at least one RPC request message using the at least one file descriptor from the at least one RPC request message; and storing the data of the least one RPC request message to the second persistent buffer, in which generating the second plurality of RPC requests from the plurality of RPC request messages may include generating at least one RPC request of the second plurality of RPC requests using the data of the at least one RPC request message from the second persistent buffer.

Example 10. The method of any of examples 1-9, further including setting a process attribute of the plurality of RPC sources, in which generating the plurality of RPC request messages from the first plurality of RPC requests includes generating the plurality of RPC request messages from the first plurality of RPC requests based on the process attribute, and setting the process attribute using the process attribute from the plurality of RPC request messages for implementing the second plurality of RPC requests.

Example 11. The method of any of examples 1-10, further including receiving a first plurality of RPC results for the second plurality of RPC requests, generating a plurality of RPC result messages from the first plurality of RPC results, sending the plurality of RPC result messages from the second virtual RPC module to the memory, retrieving the plurality of RPC result messages from the memory by the at least one first virtual RPC module, and sending the plurality of RPC result messages from the at least one first virtual RPC module to the plurality of RPC sources.

Example 12. The method of example 11, in which the at least one GVM includes a first GVM and a second GVM, the plurality of RPC sources includes the first GVM and the second GVM, the first plurality of RPC results includes a first RPC result for the first GVM and a second RPC result for the second GVM, and the at least one first virtual RPC module includes a first virtual RPC module executed by the first GVM and a first virtual RPC module executed by the second GVM, generating the plurality of RPC result messages from the first plurality of RPC results includes generating a first RPC result message from the first RPC result and a second RPC result message from the second RPC result, sending the plurality of RPC result messages from the second virtual RPC module to the memory includes pushing the first RPC result message to a first queue of the first GVM and pushing the second RPC result message to a second queue of the second GVM, and retrieving the plurality of RPC result messages from the memory by the at least one first virtual RPC module includes retrieving the first RPC result message from the first queue of the first GVM by the first virtual RPC module executed by the first GVM, and retrieving the second RPC result message from the second queue of the second GVM by the first virtual RPC module executed by the second GVM.

Example 13. The method of any of examples 11 or 12, in which the at least one GVM includes a first GVM and a second GVM, and the plurality of RPC sources includes the first GVM and the second GVM, and the at least one first virtual RPC module includes a first virtual RPC module executed by the first GVM and a first virtual RPC module executed by the second GVM, the first plurality of RPC results includes a first RPC result for the first GVM and a second RPC result for the second GVM, generating the plurality of RPC result messages from the first plurality of RPC results includes generating a first RPC result message from the first RPC result and a second RPC result message from the second RPC result, and sending the plurality of RPC result messages from the second virtual RPC module to the memory includes sending the first RPC result message and the second RPC result message to the memory, the method further includes sending a first RPC result notification for the first GVM from the second virtual RPC module to the first virtual RPC module executed by the first GVM and a second RPC result notification for the second GVM from the second virtual RPC module to the first virtual RPC module executed by the second GVM, in which retrieving the plurality of RPC result messages from the memory by the at least one first virtual RPC module includes retrieving, by the first virtual RPC module executed by the first GVM, the first RPC result message from the memory in response to receiving the first RPC result notification, and retrieving, the first virtual RPC module executed by the second GVM, the second RPC result message from the memory in response to receiving the second RPC result notification.

Example 14. The method of any of examples 11-13, in which: the first plurality of RPC requests includes a first RPC request from a first RPC source of the plurality of RPC sources; the second plurality of RPC requests includes a second RPC request derived from the first RPC request; the first plurality of RPC results for the second plurality of RPC requests includes a first RPC result for the second RPC request; generating the plurality of RPC result messages from the first plurality of RPC results includes generating the first RPC result message using at least one file descriptor for the first RPC result from a first persistent buffer; and retrieving the plurality of RPC result messages from the memory by the at least one first virtual RPC module includes retrieving the at least one file descriptor for the first RPC result from a second persistent buffer, the method further including freeing the first persistent buffer storing the at least one file descriptor for the first RPC result, and freeing the second persistent buffer storing the at least one file descriptor for the first RPC result.

Example 15. The method of any of examples 1-14, in which the plurality of RPC sources includes one or more of a plurality of guest virtual machines, a plurality of applications running on a guest virtual machine, or at least one application running on each of a plurality of guest virtual machines.

Computer program code or “program code” for execution on a programmable processor for carrying out operations of the various embodiments may be written in a high level programming language such as C, C++, C #, Smalltalk, Java, Javascript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

1. A method executing in a first processor of a computing device of implementing remote procedure calls (RPCs), wherein the first processor is configured to execute a plurality of guest virtual machines (GVMs) in parallel, the method comprising:
receiving a first plurality of RPC requests, by at least one first virtual RPC module that is executed by at least one GVM of the plurality of GVMs, from a plurality of RPC sources that are executed concurrently by the at least one GVM;
generating, by the at least one first virtual RPC module, a plurality of RPC request messages from the first plurality of RPC requests;
sending the plurality of RPC request messages from the at least one first virtual RPC module to a memory of the computing device;
retrieving the plurality of RPC request messages from the memory by a second virtual RPC module that is executed by the first processor; and
generating, by the second virtual RPC module, a second plurality of RPC requests for the plurality of RPC request messages.

2. The method of claim 1, wherein receiving the first plurality of RPC requests comprises receiving the first plurality of RPC requests concurrently.

3. The method of claim 1, wherein:
the first plurality of RPC requests includes a first RPC request and a second RPC request from a first RPC source of the plurality of RPC sources;
the first RPC request is directed to a second processor of the computing device and the second RPC request is directed to a third processor of the computing device; and
generating the second plurality of RPC requests for the plurality of RPC request messages comprises generating a third RPC request directed to the second processor and a fourth RPC request directed to the third processor.

4. (canceled)

5. The method of claim 1, wherein:
the at least one GVM includes a first GVM and a second GVM, the plurality of RPC sources includes the first GVM and the second GVM and the first plurality of RPC requests includes a first RPC request from the first GVM and a second RPC request from the second GVM;
generating the plurality of RPC request messages from the first plurality of RPC requests comprises generating a first RPC request message from the first RPC request and a second RPC request message from the second RPC request;
sending the plurality of RPC request messages from the at least one first virtual RPC module to the memory comprises pushing the first RPC request message to a first queue for the first GVM and pushing the second RPC request message to a second queue for the second GVM; and
retrieving the plurality of RPC request messages from the memory by the second virtual RPC module comprises retrieving the first RPC request message from the first queue for the first GVM and retrieving the second RPC request message from the second queue for the second GVM.

6. (canceled)

7. The method of claim 1, wherein:
the plurality of RPC sources includes a first application and a second application and the first plurality of RPC requests includes a first RPC request from the first application and a second RPC request from the second application; and
generating the second plurality of RPC requests for the plurality of RPC request messages comprises generating a third RPC request from the first application and a fourth RPC request from the second application,
the method further comprising:
pushing the third RPC request to a first thread pool for the first application; and
pushing the fourth RPC request to a second thread pool for the second application.

8. The method of claim 1, wherein:
generating the plurality of RPC request messages from the first plurality of RPC requests comprises generating the plurality of RPC request messages with data of the plurality of RPC request messages from a first buffer and a buffer attribute of the first buffer; and
generating the second plurality of RPC requests from the plurality of RPC request messages comprises:
mapping a second buffer using the buffer attribute;
storing the data of the plurality of RPC request messages to the second buffer; and
generating the second plurality of RPC requests using the data of the plurality of RPC request messages from the second buffer.

9. The method of claim 1, wherein:
the first plurality of RPC requests includes at least one RPC request from a first RPC source of the plurality of RPC sources; and
generating the plurality of RPC request messages from the first plurality of RPC requests comprises generating at least one RPC request message using at least one file descriptor from a first persistent buffer for data of the at least one RPC request message, the method further comprising:
mapping a second persistent buffer for use by the first RPC source;
retrieving the data of the at least one RPC request message using the at least one file descriptor from the at least one RPC request message; and
storing the data of the least one RPC request message to the second persistent buffer,
wherein generating the second plurality of RPC requests from the plurality of RPC request messages comprises generating at least one RPC request of the second plurality of RPC requests using the data of the at least one RPC request message from the second persistent buffer.

10. (canceled)

11. The method of claim 1, further comprising:
receiving a first plurality of RPC results for the second plurality of RPC requests;
generating a plurality of RPC result messages from the first plurality of RPC results;
sending the plurality of RPC result messages from the second virtual RPC module to the memory;
retrieving the plurality of RPC result messages from the memory by the at least one first virtual RPC module; and
sending the plurality of RPC result messages from the at least one first virtual RPC module to the plurality of RPC sources.

12. The method of claim 11, wherein:
the at least one GVM includes a first GVM and a second GVM, the plurality of RPC sources includes the first GVM and the second GVM, the first plurality of RPC results includes a first RPC result for the first GVM and a second RPC result for the second GVM, and the at least one first virtual RPC module includes a first virtual RPC module executed by the first GVM and a first virtual RPC module executed by the second GVM;
generating the plurality of RPC result messages from the first plurality of RPC results comprises generating a first RPC result message from the first RPC result and a second RPC result message from the second RPC result;
sending the plurality of RPC result messages from the second virtual RPC module to the memory comprises pushing the first RPC result message to a first queue of the first GVM and pushing the second RPC result message to a second queue of the second GVM; and
retrieving the plurality of RPC result messages from the memory by the at least one first virtual RPC module comprises:
retrieving the first RPC result message from the first queue of the first GVM by the first virtual RPC module executed by the first GVM; and
retrieving the second RPC result message from the second queue of the second GVM by the first virtual RPC module executed by the second GVM.

13. (canceled)

14. The method of claim 11, wherein:
the first plurality of RPC requests includes a first RPC request from a first RPC source of the plurality of RPC sources;
the second plurality of RPC requests includes a second RPC request derived from the first RPC request;
the first plurality of RPC results for the second plurality of RPC requests includes a first RPC result for the second RPC request;
generating the plurality of RPC result messages from the first plurality of RPC results comprise generating a first RPC result message using at least one file descriptor for the first RPC result from a first persistent buffer;
retrieving the plurality of RPC result messages from the memory by the at least one first virtual RPC module comprises retrieving the at least one file descriptor for the first RPC result from a second persistent buffer,
the method further comprising:
freeing the first persistent buffer storing the at least one file descriptor for the first RPC result; and
freeing the second persistent buffer storing the at least one file descriptor for the first RPC result.

15. The method of claim 1, wherein the plurality of RPC sources includes one or more of a plurality of guest virtual machines, a plurality of applications running on a guest virtual machine, or at least one application running on each of a plurality of guest virtual machines.

16. A computing device, comprising:
a memory; and
a first processor communicatively connected to the memory, configured to execute a plurality of guest virtual machines (GVMs) in parallel, and configured with processor-executable instructions to:
receive a first plurality of remote procedure call (RPC) requests, by at least one first virtual RPC module that is executed by at least one GVM of the plurality of GVMs, from a plurality of RPC sources that are executed concurrently by the at least one GVM;
generate, by the at least one first virtual RPC module, a plurality of RPC request messages from the first plurality of RPC requests;
send the plurality of RPC request messages from the at least one first virtual RPC module to the memory;
retrieve the plurality of RPC request messages from the memory by a second virtual RPC module; and
generate, by the second virtual RPC module, a second plurality of RPC requests for the plurality of RPC request messages.

17. (canceled)

18. (canceled)

19. (canceled)

20. The computing device of claim 16, wherein:
the at least one GVM includes a first GVM and a second GVM, the plurality of RPC sources includes the first GVM and the second GVM and the first plurality of RPC requests includes a first RPC request from the first GVM and a second RPC request from the second GVM; and
the first processor is further configured with processor-executable instructions to:
generate the plurality of RPC request messages from the first plurality of RPC requests by generating a first RPC request message from the first RPC request and a second RPC request message from the second RPC request;
send the plurality of RPC request messages from the at least one first virtual RPC module to the memory by pushing the first RPC request message to a first queue for the first GVM and pushing the second RPC request message to a second queue for the second GVM; and
retrieve the plurality of RPC request messages from the memory by the second virtual RPC module by retrieving the first RPC request message from the first queue for the first GVM and retrieving the second RPC request message from the second queue for the second GVM.

21. The computing device of claim 16, wherein:
the at least one GVM includes a first GVM and a second GVM, the plurality of RPC sources includes the first GVM and the second GVM, the first plurality of RPC requests includes a first RPC request from the first GVM and a second RPC request from the second GVM, and the at least one first virtual RPC module includes a first virtual RPC module executed by the first GVM and a first virtual RPC module executed by the second GVM; and
the first processor is further configured with processor-executable instructions to:
generate the plurality of RPC request messages from the first plurality of RPC requests by:
generating a first RPC request message from the first RPC request by the first virtual RPC module executed by the first GVM; and
generating a second RPC request message from the second RPC request by the first virtual RPC module executed by the second GVM;
send the plurality of RPC request messages from the at least one first virtual RPC module to the memory by:
sending the first RPC request message by the first virtual RPC module executed by the first GVM to the memory; and
sending the second RPC request message by the first virtual RPC module executed by the second GVM to the memory;
send a first RPC request notification for the first GVM from the first virtual RPC module executed by the first GVM to the second virtual RPC module;
send a second RPC request notification for the second GVM from the first virtual RPC module executed by the second GVM to the second virtual RPC module; and
retrieve the plurality of RPC request messages from the memory by the second virtual RPC module by:
retrieving the first RPC request message from the memory in response to receiving the first RPC request notification; and
retrieving the second RPC request message from the memory in response to receiving the second RPC request notification.

22. The computing device of claim 16, wherein:
the plurality of RPC sources includes a first application and a second application and the first plurality of RPC requests includes a first RPC request from the first application and a second RPC request from the second application; and
the first processor is further configured with processor-executable instructions to:
generate the second plurality of RPC requests for the plurality of RPC request messages by generating a third RPC request from the first application and a fourth RPC request from the second application;
push the third RPC request to a first thread pool for the first application; and
push the fourth RPC request to a second thread pool for the second application.

23. The computing device of claim 16, wherein the first processor is further configured with processor-executable instructions to:
generate the plurality of RPC request messages from the first plurality of RPC requests by generating the plurality of RPC request messages with data of the plurality of RPC request messages from a first buffer and a buffer attribute of the first buffer; and
generate the second plurality of RPC requests from the plurality of RPC request messages by:
mapping a second buffer using the buffer attribute;
storing the data of the plurality of RPC request messages to the second buffer; and
generating the second plurality of RPC requests using the data of the plurality of RPC request messages from the second buffer.

24. (canceled)

25. The computing device of claim 16, wherein the first processor is further configured with processor-executable instructions to:
set a process attribute of the plurality of RPC sources;
generate the plurality of RPC request messages from the first plurality of RPC requests by generating the plurality of RPC request messages from the first plurality of RPC requests based on the process attribute; and
set the process attribute using the process attribute from the plurality of RPC request messages for implementing the second plurality of RPC requests.

26. The computing device of claim 16, wherein the first processor is further configured with processor-executable instructions to:
receive a first plurality of RPC results for the second plurality of RPC requests;
generate a plurality of RPC result messages from the first plurality of RPC results;
send the plurality of RPC result messages from the second virtual RPC module to the memory;
retrieve the plurality of RPC result messages from the memory by the at least one first virtual RPC module; and
send the plurality of RPC result messages from the at least one first virtual RPC module to the plurality of RPC sources.

27. (canceled)

28. The computing device of claim 26, wherein:
the at least one GVM includes a first GVM and a second GVM, and the plurality of RPC sources includes the first GVM and the second GVM, and the at least one first virtual RPC module includes a first virtual RPC module executed by the first GVM and a first virtual RPC module executed by the second GVM;
the first plurality of RPC results includes a first RPC result for the first GVM and a second RPC result for the second GVM; and
the first processor is further configured with processor-executable instructions to:
generate the plurality of RPC result messages from the first plurality of RPC results by generating a first RPC result message from the first RPC result and a second RPC result message from the second RPC result; and
send the plurality of RPC result messages from the second virtual RPC module to the memory by sending the first RPC result message and the second RPC result message to the memory;
send a first RPC result notification for the first GVM from the second virtual RPC module to the first virtual RPC module executed by the first GVM and a second RPC result notification for the second GVM from the second virtual RPC module to the first virtual RPC module executed by the second GVM; and
retrieve the plurality of RPC result messages from the memory by the at least one first virtual RPC module by:
retrieving, by the first virtual RPC module executed by the first GVM, the first RPC result message from the memory in response to receiving the first RPC result notification; and
retrieving, the first virtual RPC module executed by the second GVM, the second RPC result message from the memory in response to receiving the second RPC result notification.

29. (canceled)

30. A computing device, comprising:
means for receiving a first plurality of remote procedure call (RPC) requests, that is executed by at least one GVM of a plurality of GVMs, from a plurality of RPC sources that are executed concurrently by the at least one GVM;
means for generating a plurality of RPC request messages from the first plurality of RPC requests;
means for sending the plurality of RPC request messages to a memory of the computing device;
means for retrieving the plurality of RPC request messages from the memory; and
means for generating a second plurality of RPC requests for the plurality of RPC request messages.
